(19) United States
(12) Patent Application Publication
(10) Pub. No.: US 2010/0299979 A1
(43) Pub. Date: Dec. 2, 2010

(54) APPAREL HAVING A MEANS FOR DISPLAYING AN OBJECT

(76) Inventor: Michael LaMere, Rochester, NY (US)

Correspondence Address: LAW OFFICE OF TRACY P. JONG, 2775 BUFFALO ROAD, SUITE 3, ROCHESTER, NY, 14624, US

(21) Appl. No.: 12/784,669

(22) Filed: May 21, 2010

Related U.S. Application Data
(60) Provisional application No. 61/181,546, filed on May 27, 2009.

(51) Int. Cl. G09F 3/00

(52) U.S. Cl. 40/329

(57) ABSTRACT

The invention relates to an improved article of head apparel having a means for displaying at least one object. The article of head apparel in its wearable state is comprised of a display object housed in an object display module, fitted to the article of head apparel. In one embodiment there is provided an article of head apparel having removably attachable object display modules which enable the user to easily customize the unit. Another embodiment includes the means for permanently attaching an object display module to the article of head apparel. Other embodiments enable an article of head apparel with the capability of accepting and displaying more than one object display module.

### RELATED APPLICATIONS AND PRIORITY CLAIM

This application claims priority to U.S. Ser. No. 61/181,546 a provisional application filed in the name of Michael LaMere, on May 27, 2009. This application is incorporated by reference herein in its entirety.

### FIELD OF THE INVENTION

This application generally relates to apparel; and more particularly head apparel having a means for displaying an object.

### BACKGROUND OF THE INVENTION

Collectors in general, especially coin and stamp collectors commonly possess objects of monetary value, historical significance, personal value, marketing value, and the like. Collectors often go to great lengths to preserve and protect the objects or collectables comprising their collections.

Often, collector items or display objects (e.g. coins) are individually wrapped in a blister, holder, or an object display module such as a one piece transparent clam-shell type holder, two piece version, or the like. Such object display modules protect the objects from environmental hazards such as dust, dirt as well as those presented by handling (e.g. scratches, fingerprints, etc.). In general, object display modules or like devices must be transparent on at least one side to enable object viewing. Other more sophisticated object display modules are transparent on front, in addition to the back side, and are sometimes constructed to enable viewing of an object's side (e.g. a coin's edge, where inscriptions are occasionally found). Such advanced display modules designs enable complete viewing of an object such as a coin, medallion, or the like.

An object display module can be modified by subsequent processes so as to permanently house a display object. Processes to permanently incase display objects include stitching, rivets, heat staking, welding, glue, or the like. Alternately, display objects can be secured in the object display module in a less permanent fashion so to permit the exchanging of display objects given a particular object display module. Less permanent means of fastening an object display module closed include staples, hook and loop, snaps, and the like.

Object display modules of leading quality are produced from materials and processes that provide optical clarity as well as archival stability. Object display modules are expected to provide years of quality service, free of defects such as distortions, discolorations, and cracking. Such modules are popular among collectors due to the fact that they provide substantial object protection whether storing or displaying collection objects at a relatively low cost.

There is a long felt need among collectors to be able to publicly display the objects of their collectables, so to share in the objects beauty, convey a message, make a public statement, or the like. Possible messages include that of celebration, dedication, and marketing. Examples include, displaying a coin having the image of the Liberty Bell thereon to celebrate Fourth of July based events, or displaying a sports commemorative medallion to a target sporting event, are but a few examples of a myriad of possibilities. It is understood that wearing such collectables must not come at the expense of the collectable item, i.e. the collectable must not be damaged or placed in a situation of unreasonable risk.

Several of the references below disclose a flexible polymeric window permanently incorporated into a hat or cap, creating a pocket like storage areas that are not custom fitted to the collectable. Such uncontrolled, loose-fitting retaining systems can permit the collectable to slide, bounce, break-free, etc., thereby creating increased risk for scratches, nicks, and the like. Furthermore, many relatively inexpensive materials that typically comprise flexible polymeric windows possess properties that can induce defects and/or increase the risk of object damage. For example, polyvinylchloride (vinyl) type polymers are known to outgas agents such as hydrochloric acid, chloroethylene epoxide, and formic acid, which that have been known to cause pitting and hazing on proof type finishes, the proof finish is commonly found on surfaces of coins, medallions, and the like. The agent outgassing rate is hastened when such polymeric materials are exposed to humidity and/or sunlight (expected environmental conditions associated with usage of a window based hat). Another disadvantage of polyvinylchloride is its tendency to discolor and crack. Polyethylene terephthalate (polyester), is yet another common material that flexible polymeric window can be constructed from; this material does not suffer from the outgassing issues as does polyvinylchloride, but commonly possess horizontal striations, which can interfere with quality object viewing.

Description/discussion of the related art; the following references describe headware apparel that utilize display window(s) that are permanently integrated into headware type of apparel: U.S. Pat. No. 2,803,829 to Tscharner, U.S. Pat. No. 4,451,935 to Henschel, U.S. Pat. No. 5,465,426 to Beaton, U.S. Pat. No. 5,452,479 to Mostert, and U.S. Pat. No. 5,581,813 to Henschel. Furthermore, the aforementioned references describe devices having external slots, doors, or openings designed to receive the article or object to be displayed being located on the outside surface of the headware. Such configurations enable environmental elements (e.g. rain, dust, and the like) easy access to the article display area, thereby creating an increased risk for article damage. Permanently attached window materials tend to deteriorate, especially in harsh environmental conditions such as direct sunlight, high humidity, and the like. Such conditions often promote the outgassing rate associated with plasticizers or dispersant type additives often incorporated in window materials. The loss of such additives will contribute to window cracking, leading to object damage, and/or object loss. Additionally, to view the backside of articles mounted in such devices, the article must be removed from the display pocket.

The aforementioned references in the previous discussion reveals many shortcomings associated with apparel designs incorporating permanent window type materials. The purpose of the present invention is to overcome several of the shortcomings affiliated with the prior art as well as the introduction of additional novel features.

### SUMMARY OF THE INVENTION

The present invention relates to an article of head apparel having a means for displaying at least one article or object. The article of head apparel in its fully assembled state is comprised of an object display module (designed to hold the display object) fitted to the article of head apparel. The intention is to provide users with an article of head apparel in combination with an object display module, the article of head apparel adapted to receive the object display module, as well as standalone object display modules.

It is understood that the article of head apparel in certain embodiments can accommodate a plurality of object display modules; similarly, a display object can be comprised of a plurality of separate items e.g. several small coins contained in a single object display module. Object display modules can display a multitude of items depending on the intention of the wearer. Display items include, but not limited to; coins, stamps, medals, poker chips, casino chips, insects; as well as providing novelty type displays (e.g. beach sand, ocean water, and the like). In one aspect of the present invention, the object display module is replaceable or exchangeable with modules enabling simple appearance changes to the head apparel; in other embodiments, an object display module can be permanently affixed to the article of head apparel.

In accordance with this invention, and in one embodiment thereof, there is provided an article of head apparel having interchangeable object display module enabling the user to easily customize the article of apparel.

Accordingly, it is an object of the present invention to provide an improved article of head apparel that accommodates an object display module designed to house a display object.

It is an object of the present invention to provide an object display module that safely stores a display object (e.g. coin, medallion, and the like).

It is an object of the present invention to provide an object display module that mounts from the inner portion of the improved article of head apparel, resulting in enhanced mounting characteristics, e.g. greater security.

It is an object of the present invention to provide an improved article of head apparel that uses an object display module to exhibit the front and side views of a display object as presented to a viewer via the outer surface of the improved article of head apparel.

It is an object of the present invention to provide an improved article of head apparel that uses an object display module to exhibit the back side of a display object. The back side of a display object is viewable from the inner surface of the improved article of head apparel.

It is yet another object of this invention to provide an improved article of head apparel that is economical from the viewpoint of the manufacturer and consumer, is susceptible of low manufacturing costs with regard to labor and materials, and which accordingly is then susceptible of low prices for the consuming public, thereby making it economically available to the buying public.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the conception regarded as the present invention.

### PARTICULAR ADVANTAGES OF THE INVENTION

The present invention provides several advantages, including the use of an object display module(s) that functions to securely hold and display a display object such as a coin, and a corresponding item of wearable apparel designed to accept the module for safe display. The object display module is preferably constructed from archival safe materials. One novel aspect of the object display module is that it possesses a rear panel elevated display window and corresponding front panel, such that the assembly substantially projects the contained display object forward, beyond the outer surface of the article of head apparel. The projecting feature associated with the display object yields provides pronounced display object viewing where the side or edge of the display object is clearly visible as is the front face.

In one embodiment of the present invention a user is provided a means for removably attaching object display module(s) to a baseball cap type of head apparel. Users are provided an opportunity to organize their collection (e.g. coins) in object display modules in typical storage containers, with the option to select any member of their collection for wearable display. Such a system provides a simple, cost effective means for changing the appearance of wearable apparel, e.g. a baseball cap, as well as providing a means for displaying various objects of one's collection that typically is not publicly displayed, nor used as wearable ornamentation.

### BRIEF DESCRIPTION OF THE DRAWINGS

The invention will be described by reference to the specification and the drawings, in which like numerals refer to like elements, and wherein:

FIG. 1 illustrates a perspective front-side view of a visor and crown type article of head apparel having an aperture on the crown portion.

FIG. 2A illustrates an exploded front-side perspective view of an object display module comprising a front panel and a rear panel.

FIG. 2B illustrates a cut-away orthogonal side view of an unassembled object display module comprising a front panel and a rear panel.

FIG. 2C illustrates a cut-away orthogonal side view of an assembled object display module comprising a front panel and a rear panel having a display object therein. This figure also shows the novel projection feature where the display object is substantially elevated above the front base of the object display module.

FIG. 3 illustrates a perspective front-side view of a visor and crown type article of head apparel having an aperture having an object display module mounted therein.

FIG. 4A illustrates a perspective bottom-side view of a visor and crown type article of head apparel showing inner surface having a retaining flap with a retaining flap aperture.

FIG. 4B illustrates a perspective exploded bottom-side view of a visor and crown type article of head apparel showing the inner surface having a retaining flap with a retaining flap aperture. An exemplary mounting scheme of an object display module to a crown type article of head apparel is also presented.

FIG. 5A illustrates a side orthogonal view of a visor and crown type article of head apparel having an object display module mounted therein.

FIG. 5B illustrates a cut-away orthogonal side view bisecting a visor and crown type article of head apparel showing an object display module mounted therein.

The drawings are not to scale, in fact, some aspects have been emphasized for a better illustration and understanding of the written description.

### DEFINITIONS OF TERMS USED IN THIS SPECIFICATION

The article of head apparel having a means for displaying at least one object thereof aforementioned shall have equivalent nomenclature including: the device, the unit, the present invention, or the invention. The term display object shall refer to the contents stored or to be stored in the object display module; the contents is not limited to a single item (such as a coin), but can refer to a plurality of objects, or materials without form (e.g. sand, water, and the like) contained therein.

Additionally, when describing objects possessing a generally rectangular geometry, the terms short dimension, short side, or width shall refer to the shorter or smaller of the two sides or edges of the rectangular object. Whereas, the terms elongated dimension, elongated side, or length shall refer to the longer or larger of the two sides or edges of the rectangular object. Also, the term rectangular is understood to include case where all sides of the geometric shape are of equal length, also known as an equilateral rectangle or a square.

Also, in this disclosure, the term “exemplary” shall possess only one meaning; wherein the sole definition pertains to serving as an example, instance, or illustration. The term assemblage shall mean the unassembled or partially assembled collection of related components, including; an article of head apparel, an object display module, a display object, or any combination thereof. Variations of the assemblage can resemble a kit, as well as situations where final assembly is required by the end user.

In order to help facilitate the understanding of this disclosure, a parts list numbering convention has been employed. The first digit in three digit part numbers refers to the Figure number where the part was first introduced, or is best depicted. Likewise, in four digit part numbers, the first two digits refer to the Figure number where the part was first introduced, or is best depicted. Although this disclosure may at times deviate from this convention, it is the intention of this numbering convention to assist in an expeditious comprehension of this application.

### PARTS/FEATURES LIST

100. article of head apparel
102. outer surface
104. aperture
106. perimeter (of aperture 104)
108. edge finish
200. object display module
202. front panel
204. first wall
206. transparent planar front window
208. first height
209. first diameter
210. holes (front panel)
212. front base
214. short dimension (front panel)
216. elongated dimension (front panel)
218. first thickness
220. rear panel
222. holes (rear panel)
224. transparent, elevated, planar, rear window
226. second wall
228. second height
229. second diameter
230. short dimension (rear panel)
232. elongated dimension (rear panel)
234. rear base
236. second thickness
238. display chamber
240. elevated display window assembly
242. height of display chamber
243. diameter of object display module
244. height of assembled object display module
246. display object
300. article of head apparel with mounted object display module
400. article of head apparel having an object display module retaining flap
402. inner surface
404. retaining flap
406. retaining flap aperture
408. hook and loop assembly
410. mounting surface
412. inner surface of retaining flap
414. perimeter of retaining flap aperture
416. first portion of hook and loop assembly
418. second portion of hook and loop assembly

### DETAILED DESCRIPTION OF THE INVENTION

Several embodiments of the present invention relating to head apparel having a means for displaying an object are described in the following detailed description section. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

In this context, the article of head apparel 100 can be constructed from most any flexible, durable type of material. Such material properties are provided by a variety of plastics, polymers, natural fibers, composite materials, textiles, or the like (e.g. cotton, nylon, polyester). In preferred embodiments the unit is constructed from moisture resistant, wear-resistant, UV resistant, light weight, cost effective type materials such as provided by high quality natural, synthetic or synthetic/natural fiber blends (e.g. nylon, cotton-polyester, and the like).

The object display module 200 portion of the article of head apparel system may be constructed from any rigid, transparent, durable type of material such as provided by various plastics or polymers. In preferred embodiments, in addition to the aforementioned properties, the object display module would further possess archival material properties. Archival materials, in this application, are designed to provide a colorless, optically transparent, distortion-free viewing that provides long life, safe storage for the display object. Additionally, such materials should be fully compatible with the storage requirements of sensitive objects to be stored, e.g. proof type coins. It has been reported that some plasticizers used in certain storage modules tend to mottle the surface of proof-type coins and the like. Some archival materials are fabricated in such a manner where the reduction of, or the use of more stable plasticizers make them better candidates for use with such sensitive objects. The CoinEdge Two by Two holders, available from the CoinEdge Coin Holder Company, located in Cross Plains, Wis., is an example of a product constructed from a material utilizing a more stable plasticizer.

In one embodiment of the object display module, the device is constructed from two separate parts or panels. The two panels are designed to mate when closed such that the display object is securely enclosed in the created display chamber portion of the object display module. In an alternate embodiment, the object display module can be constructed from one continuous sheet where the front and back panels are connected via a living hinge. Living hinges are generally created by the formation of a relatively thin portion of polymeric material bridging the two heavier portions of the same material. Such a hinge design enables a more cost effective hinging means when compared to the typically more expensive, heavier, classical mechanical hinge. When using such a hinging technology, an object display module type of device can be constructed from one continuous piece of polymeric material followed by a subsequent hinge forming process (the formation of “Living hinges” is a well known process/technology in the polymeric industry).

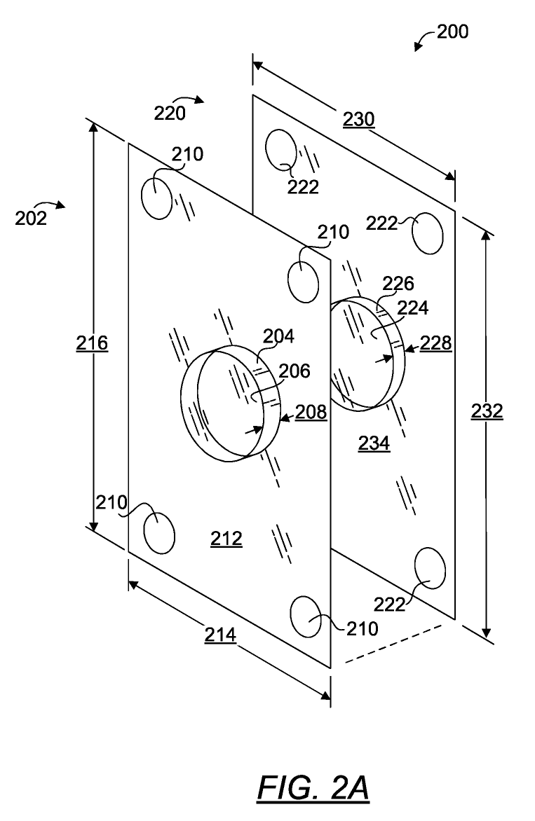

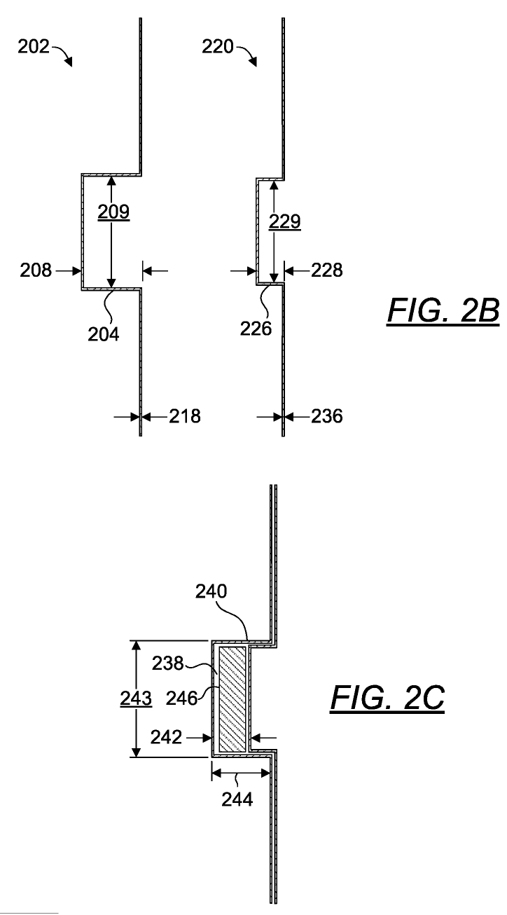

The display chamber 238 of the assembled object display module depicted in FIG. 2C is shown as round cylinder for exemplary purposes only. While such a geometry type is generally best suited for round coin geometries, there is no such geometric limitation placed on display chamber 238. The overall appearance of display chamber 238 can take on a multitude of geometries, including, but not limited to; squares, triangles, stars, sector (pie-cut) geometries, and the like. Display chamber 238 is formed by the joining of front panel 202 to rear panel 220.

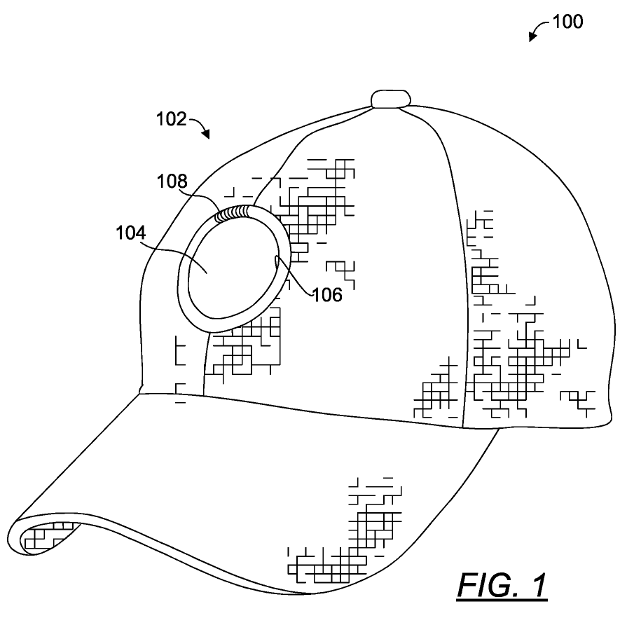

FIG. 1 illustrates a perspective front-side view of article of head apparel 100, having outer surface 102, aperture 104 having an edge finish 108 about perimeter 106. Examples of an edge finish 108 include; cording, piping, binding, casing, and the like. These as well as other methods of finishing an edge are well known in the sewing arts. Edge finish benefits provided by edge finish 108 includes, but not limited to, a reinforced perimeter 106 that can prevent unraveling, tearing, and the like, about aperture 104. Edge finish 108 can provide an enhanced compression-fit type of fastening when mounting object display module 200 to aperture 104 by providing an increased compressive force upon first wall 204 of object display module 200; this is accomplished by effectively reducing the size of aperture 104. Additionally, edge finish 108 is capable of providing an aesthetically pleasing frame surrounding the elevated display window assembly 240; the framing look can be further be accentuated by the use of various edge finish 108 color schemes.

FIG. 2A illustrates an exploded perspective front-side view of object display module 200 comprising a front panel 202 and a separate mating rear panel 220. The dimensions of front panel 202 substantially approximate those of rear panel 220 such that a close-fitting mating condition is achieved when said panels are joined. The joining or affixing of front panel 202 to rear panel 220 creates display chamber 238 wherein display object 246 is contained. First wall 204 must be transparent to reveal the edge features of display object 246. Depicted are front panel 202 and rear panel 220 strategically aligned or positioned to reveal the functional conjoined relationship between said panels. The two panels are shown to correspondingly match like features and dimensions, wherein the short dimensions and elongated dimensions of both front panel 202 and rear panel 220 align; resulting in an object display module 200 constructed to house display object 246 when said object display module 200 is in the assembled or in the closed state or condition.

FIG. 2B illustrates a cut-away, orthogonal side view of an unassembled object display module 200 shown in FIG. 2A. FIG. 2B depicts front panel 202 having a first thickness 218, a first wall 204 having an approximate first height 208, and a first diameter 209. Also depicted is rear panel 220 having a second thickness 236, a second wall 226 having an approximate second height 228, and a second diameter 229.

FIG. 2C illustrates a cut-away, orthogonal, side view of an object display module 200 (also shown in FIGS. 2A and 2B) in the closed or assembled state showing the creation of elevated display window assembly 240 having a diameter 243 and display chamber 238 volume. Given substantially similar dimensions between front panel 202 and rear panel 220, the quality of the seal pertaining to display chamber 238 is primarily determined by first diameter 209 being slightly larger than second diameter 229 so to create a compression-fit when joined. As shown in FIG. 2C, an exemplary display object 246 is disposed within the display chamber 238. Given the dimensions of display chamber 238, display object 246 can be almost any object that can be contained therein. Examples of display object 246 are coin type objects; exemplary coins that can be used with the present invention include typical coins having relatively large diameters, e.g. 39 mm and 50 mm.

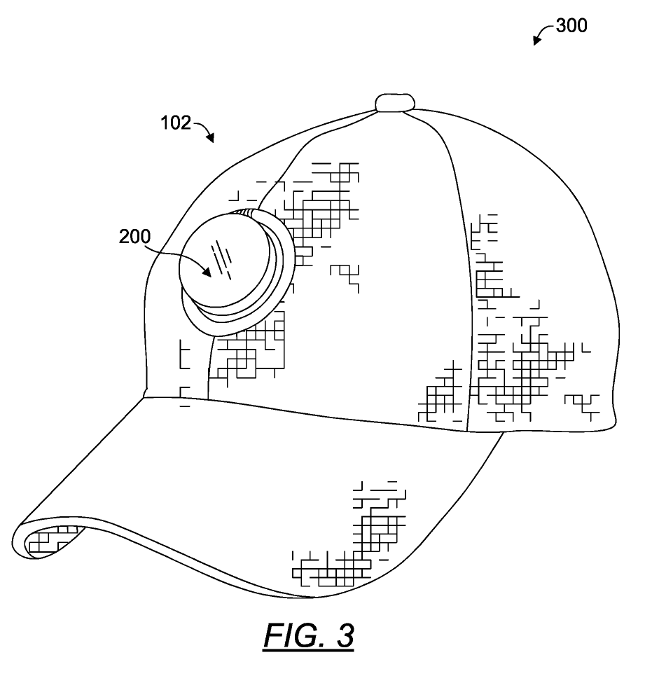

Again referring to FIG. 2A, front panel 202 is generally rectangular, planar, thin, and rigid, having a short dimension 214, an elongated dimension 216, also having a first wall 204 possessing a first height 208 connecting front base 212 to a transparent, elevated, planar, front window 206. Rear panel 220 is also generally rectangular, planar, thin, and rigid. Rear panel 220 has a short dimension 230, an elongated dimension 232, also having a second wall 226 possessing a first height 228 connecting rear base 234 to a transparent, elevated, planar, front window 224. Located at each of the four corners of front panel 202 are holes 210 designed to align with holes 222 of rear panel 220. Holes 210 once mated with corresponding holes 222 enable the use of hole-based fastening means or technologies such as snaps, screws, nuts and bolts, and the like. The hole-based fasteners function to help keep front panel 202 in contact with rear panel 220, as well as enabling an optional means of fastening object display module 200 onto article of head apparel with mounted object display module 300 (as depicted FIG. 3).

A generally rectangular structure is a preferred geometry for front panel 202 and rear panel 220. The straight edges that comprise a generally rectangular structure enable easy stable storage of object display module(s) 200 in rectangular boxes, a commonly found storage device used in the hobby of coin collecting and the like. Although, the generally rectangular structure is preferred, other geometries (e.g. circles, ovals, custom shapes) can be used.

Excluding hole-based fastening means, other means of fastening front panel 202 to rear panel 220 includes the use of fasteners or fastening processes such as; stitching, rivets, heat staking, ultrasonic welding, heat based welding, stapling, gluing, and the like. The creation of an air-tight display chamber 238 is achievable if the appropriate fastening technology and associated process is employed (e.g. gluing, ultrasonic welding, heat based or the like).

Again referring to FIG. 2B, front panel 202 has a first wall 204 possessing a first height 208 of magnitude greater than that of second height 228, a dimension possessed by second wall 226, associated with rear panel 220. The magnitude of height of display chamber 242 (depicted in FIG. 2C) is substantially determined by the differential between first height 208 and second height 228. Also, transparent, elevated, planar, rear window 224 (depicted in FIG. 2A) possesses dimensions of similar size (slightly smaller) to that of transparent, elevated, planar, front window 206 to enable coupling as shown in FIG. 2C. The joined result depicted in FIG. 2C shows the creation of elevated display window assembly 240 comprised of display chamber 238 possessing height of assembled object display module 244. Again, it is understood that the elevated display window assembly 240 is not limited to the depicted circular geometry (best depicted in FIG. 2A), but can be constructed to assume any geometry desired including ovals, rectangles, triangles, crescents, stars, and so forth. The elevated display window assembly 240 may be constructed so to form fit display objects of various and unusual geometries (e.g. starfish, butterflies, and the like).

Referring to FIGS. 2A, 2B, and 2C, exemplary dimensions are presented. Short dimensions 214 and 230 and elongated dimensions 216 and 232 of both said front panel 202 and said rear panel 200 are of substantially similar size, where short dimensions 214 and 230 constitute a range from about 1.75 inches to about 2.25 inches, and elongated dimensions 216 and 232 comprise a range from about 2.00 inches to about 2.50 inches. First height 208 example dimensions range from about 0.125 (⅛) inches to about 0.25 (¼) inches. Second height example dimensions range from about 0.0625 ( 1/16) inches to about 0.125 (⅛) inches. First thickness 218 of front panel 202 and second thickness 236 of rear panel 220 each have exemplary material thicknesses ranging from about 0.005 inches (5 mils) to about 0.050 inches (50 mils).

The object display module 200 front panel 202 and rear panel 200 are substantially constructed out of transparent polymeric material, exemplary materials include, but are not limited to, polyvinylchloride, polyester, polystyrene, polyethylene terephthalate, acrylic, or the like.

In an alternate embodiment, front panel 202 and rear panel 220 are constructed from a single piece of polymeric material such that the front panel and the rear panel are integrated as one contiguous unit having a living hinge disposed at a predetermined location such that front panel 202 aligns and mates with rear panel 200 when object display module 200 closes in bifold fashion about the living hinge.

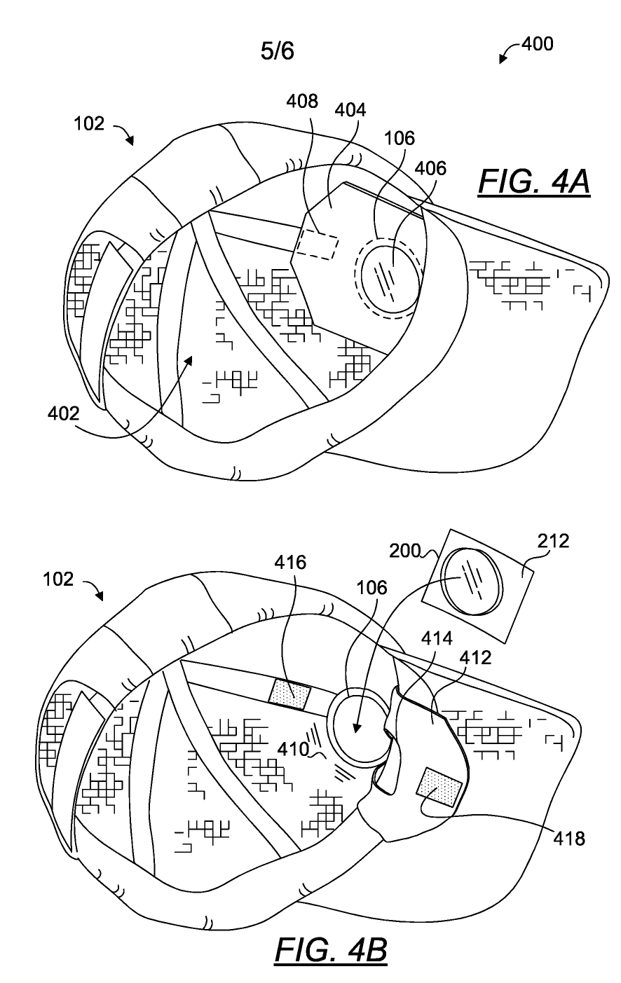

Both FIGS. 4A and 4B illustrate a perspective bottom-side view of article of head apparel having an object display module retaining flap 400 that is comprised of article of head apparel 100, showing inner surface 402 having an object display module 200 retaining flap 404 with retaining flap aperture 406. Retaining flap aperture 406 permits viewing the back side of the display object contained in the mounted object display module 200 as viewed from inner surface 402. Exemplary retaining flap 404 fastening system depicted utilizes hook and loop assembly 408 comprised of first portion of hook and loop assembly 416 and mating second portion of hook and loop assembly 418. Other means for providing the releasably-attaching function include snaps, buttons, zippers and the like. Means for permanently attaching object display module 200 to mounting surface 410 include stitching, rivets, heat staking, welding, stapling, glue, or the like. As depicted in FIG. 4B, front base 212 of object display module 200 engages mounting surface 410 while elevated display window assembly 240 of preferably similar dimensions to aperture 104 projects through aperture 104 wherein a portion of elevated display window assembly 240 resides above outer surface 102 of article of head apparel 100 (best depicted in FIG. 3).

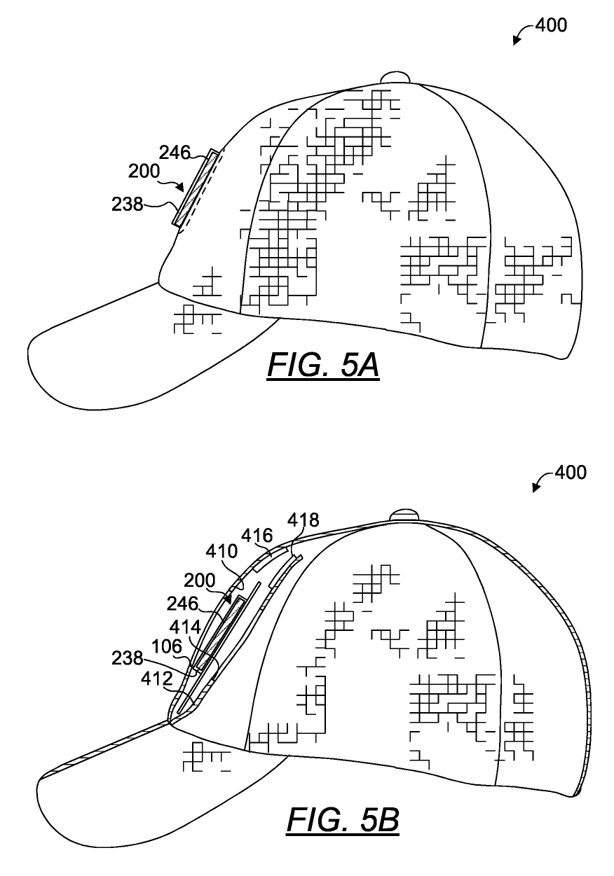

FIG. 5A illustrates a side view of an article of head apparel 400 having a mounted object display module 200. At least a portion of display chamber 238 of object display module 200 projected forward beyond the outer surface 102 to enable the display object 246 contained in display chamber 238 to protrude thereby creating a prominent display configuration for enhanced display object 246 viewing.

FIG. 5B illustrates a cut-away side view bisecting article of head apparel having an object display module retaining flap 400 with object display module 200 in a partially mounted configuration. The components shown in FIG. 4B are depicted in proper alignment in FIG. 5B to enable object display module mounting to mounting surface 410. Referring to FIGS. 5A and 5B, an exemplary display object 246 is disposed within the display chamber 238.

What is claimed herein is:

1. An article of head apparel having an outer surface and an inner surface, said inner surface adapted to receive an object display module having an elevated display window assembly, said article of head apparel comprising: at least one mounting surface disposed on said inner surface of said article of head apparel, wherein emplacement of said object display module takes place via said inner surface of said article of head apparel; said mounting surface having an aperture with predetermined dimensions such that said elevated display window assembly of similar dimensions mate with said aperture when affixed to said mounting surface, whereby contents stored within said elevated display window assembly are viewable from said outer surface of said article of head apparel;
said mounting surface further comprising a fastening system adapted to secure said object display module to said mounting surface located on said inner surface of said article of head apparel.

2. The article of head apparel of claim 1, wherein said fastening system includes a means for releasably-attaching said object display module.

3. The article of head apparel of claim 2, wherein said means for releasably-attaching is hook and loop, snaps, buttons, compression-fit, or zippers.

4. The article of head apparel of claim 1, wherein said fastening system includes a means for permanently attaching said object display module.

5. The article of head apparel of claim 4, wherein said means for permanently attaching is stitching, rivets, heat staking, welding, stapling or glue.

6. The article of head apparel of claim 1, wherein said aperture includes an edge finish about the perimeter of said aperture.

7. The article of head apparel of claim 6, wherein said edge finish is cording, piping, binding, or casing.

8. A head apparel assemblage comprising:
an article of head apparel;
an object display module;
said article of head apparel having an outer surface and an inner surface, and at least one mounting surface disposed on said inner surface therein, further comprising an aperture having predetermined dimensions adapted to accept said object display module having an elevated display window assembly; and a fastening means to secure said object display module to said inner surface of said article of head apparel;
said object display module having an elevated display window assembly possessing similar said predetermined aperture dimensions, said object display module further comprising:
a front panel being generally planar, thin, and rigid, having a first wall connecting a front base to a transparent, elevated, planar, front window;
a rear panel being generally planer, thin, and rigid, having a second wall connecting a rear base to a transparent, elevated, planar, rear window having substantially similar predetermined dimensions to said front window;
a display chamber having a display chamber height that is substantially defined by the distance between said front window and said rear window when said object display module is in the assembled state.

9. The head apparel assemblage of claim 8, wherein said object display module is affixed to said article of head apparel such that said display chamber projects through said aperture whereby any contents contained within said elevated display window assembly are viewable from said outer surface of said article of head apparel.

10. The head apparel assemblage of claim 8, wherein said object display module having a generally rectangular said front panel and a generally rectangular said rear panel, each having a short dimension and an elongated dimension.

11. The head apparel assemblage of claim 10, wherein said generally rectangular said front panel and a generally rectangular said rear panel each having a said short dimension and said elongated dimension of substantially similar values, wherein said short dimension possessing a range from about 1.50 inches to about 2.00 inches, and said elongated dimension possessing a range from about 1.50 inches to about 2.00 inches, such that said short dimensions and said elongated dimensions of said front panel and said rear panel, correspondingly align, respectively, when said front panel and said rear panel are conjoined.

12. The head apparel assemblage of claim 10, wherein said generally rectangular said front panel and a generally rectangular said rear panel each having a said short dimension and said elongated dimension of substantially similar values, wherein said short dimension possessing a range from about 1.90 inches to about 2.50 inches, and said elongated dimension possessing a range from about 1.90 inches to about 2.50 inches, such that said short dimensions and said elongated dimensions of said front panel and said rear panel, correspondingly align, respectively, when said front panel and said rear panel are conjoined.

13. The head apparel assemblage of claim 8, wherein said aperture includes an edge finish about the perimeter of said aperture.

14. The head apparel assemblage of claim 13, wherein said edge finish is cording, piping, binding, or casing.

15. An object display module having an elevated display window assembly adapted to be received by an aperture having predetermined dimensions disposed on an inner mounting surface of an article of head apparel, such that said elevated display window assembly of the said object display module is visible from an outer surface of said article of head apparel, said object display module comprising:
a front panel being generally rectangular, planar, thin, and rigid, having a short dimension, an elongated dimension, comprising a first wall having a first height connecting a front base to a transparent, elevated, planar, front window having predetermined dimensions;
a rear panel being generally rectangular, planer, thin, and rigid, having a short dimension, a elongated dimension, comprising a second wall having a second height, connecting a rear base to a transparent, elevated, planar, rear window having substantially similar predetermined dimensions to those of said front window;
a display chamber having a display chamber height substantially defined by the height differential between said first height and said second height;
said short dimension and said elongated dimension of both said front panel and said rear panel are of substantially similar values, where said short dimension possessing a range from about 1.75 inches to about 2.25 inches, and said elongated dimension possessing a range from about 2.00 inches to about 2.50 inches;
said first height ranges from about 0.125 (⅛) inches to about 0.25 (¼) inches;
said second height ranges from about 0.0625 ( 1/16) inches to about 0.125 (⅛) inches;
said front panel and said rear panel each having a material thickness range from about 0.005 inches (5 mils) to about 0.05 inches (50 mils).

16. The object display module of claim 15, wherein said front panel and said rear panel are substantially constructed out of a polymeric material.

17. The object display module of claim 15, wherein said polymeric material is polyvinylchloride, polyester, polystyrene, polyethylene terephthalate, or acrylic.

18. The object display module of claim 15, wherein said front panel and said rear panel are constructed from a single piece of polymeric material such that said front panel and said rear panel are integrated as one contiguous unit having a living hinge disposed at a predetermined location such that said front panel aligns and mates with said rear panel when said object display module is closed in bifold fashion about said living hinge.

19. The object display module of claim 18, wherein said front panel and said rear panel are bonded to each other using a fastening means, wherein said fastening means is stitching, rivets, heat staking, welding, stapling, compression-fit or glue.

20. The object display module of claim 15, wherein said display chamber further including a plurality of corresponding holes disposed about the perimeter region of both said front panel and said rear panel, such that resulting object display module through holes enable hole-based fastening means.
